(19) United States
(12) Patent Application Publication
(10) Pub. No.: US 2006/0193501 A1
(43) Pub. Date: Aug. 31, 2006

(54) Apparatus for photographing iris pattern

(76) Inventor: Woong-Tuk Yoo, Seoul (KR)

Correspondence Address: MAYER, BROWN, ROWE & MAW LLP, 1909 K STREET, N.W., WASHINGTON, DC, 20006, US

(21) Appl. No.: 10/562,878

(22) PCT Filed: Sep. 9, 2004
(86) PCT No.: PCT/KR04/02299

§ 371 Date: Dec. 29, 2005

(30) Foreign Application Priority Data
Sep. 9, 2003 (KR) 1020030063427

(51) Int. Cl. G06K 9/00

(52) U.S. Cl. 382/117

(57) ABSTRACT

Provided is an iris pattern photographing apparatus can photograph an iris of a person clearly even in a low-level illumination without a complicated device by using a simple-structured short lens capable of photographing the iris in a predetermined distance, and making the person place his iris within the focal length of a digital camera easily; and it can be produced at a low cost and carried and set up conveniently. The apparatus includes a body case; a short lens digital camera, which is set up in the body case and includes a lens module and an imaging device; LED lamps, which are set up around a lens of the digital camera, for providing illumination; a power supplying means for supplying power source to the digital camera and the LED lamps; and a focal lens combined with a lens of the digital camera in the front for close contact photographing.

### TECHNICAL FIELD

The present invention relates to an iris pattern photographing apparatus used in an identification authentication system; and, more particularly, to an apparatus for photographing an iris pattern that can be fabricated at a low cost by using a simple illumination scheme with a few Light Emitting Diodes (LED) capable of inputting an image clearly even at a low illumination level and using a short lens that does not require a focus controlling means, miniaturized to thereby improve portability, and used generally regardless of the place of installation.

### BACKGROUND ART

Generally, identification authentication systems for a security purpose identify a person by comparing a physical characteristic, such as a fingerprint, voice, a vein pattern and the like, with registered data. Recently, it is known that an iris pattern can be used as a medium for identifying a person, and an identification authentication system using the iris pattern as a medium for identifying a person can have a superior discrimination to other conventional security media.

That is, each person has a different iris pattern. The iris pattern is completed in 18 months after birth, and it is scarcely changed ever since. Because the iris pattern has a superior discrimination and diversity to other physical characteristics, various methods are suggested to apply the iris pattern to an identification authentication system for a security purpose such as entrances of a building and safes in banks.

A conventional structure of an identification authentication system based on iris recognition comprises a photographing apparatus for photographing an iris pattern of a person, an image analyzer for analyzing an iris pattern image inputted from the photographing apparatus, a storage for storing a reference iris image to be compared with, and a controller for outputting a control signal for operating a peripheral device, for example, a control signal for locking/unlocking a lock device, based on the result from the image analyzer.

The identification authentication system based on iris recognition identifies a person by comparing an iris image (pattern) photographed through the photographing apparatus with a pre-registered iris pattern. Therefore, the performance of the photographing apparatus becomes a significant factor for precise discrimination.

A conventional iris pattern photographing apparatus comprises a camera for photographing an iris pattern of a person, an illumination module for providing light for photographing of the camera, a distance measuring module for measuring a distance from the camera to the iris, a focal distance adjusting module for adjusting a focal distance of a lens based on a signal inputted from the distance measuring module. The iris pattern photographing apparatus puts the iris pattern of a person to be identified and the focal axis in the same line and measures the distance to the iris with a distance measuring sensor, and photographs the iris image by adjusting the focus of the camera lens based on the measured distance.

However, the conventional iris pattern photographing apparatus requires a process of measuring the distance to the iris and a process of adjusting a camera focus based on the distance. This wastes much time on photographing the iris image of a user and, further, it requires a distance measuring module for adjusting a focus automatically and a controller for controlling the distance measuring module necessarily. Therefore, there is a problem that the structure of the iris pattern photographing apparatus is complicated and the production cost is high.

Also, since an analog camera is used for the iris pattern photographing apparatus generally, a converter for converting the photographed iris pattern of the person into digital signals is required additionally. In addition, since a high-level illumination is required for photographing, an illuminator and an illuminator controller should be added and this adds to the complication in structure. Therefore, the present invention applies a digital camera to the iris pattern photographing apparatus, instead of an analog camera.

However, the photographed image quality of digital camera, too, is affected by the brightness and location of the illuminator. Particularly, an image photographed by a digital camera under a low-level illumination shows local blots whose color is far off the colors of the surroundings.

Therefore, the conventional iris pattern photographing apparatus using a digital camera can hardly provide an exact photograph of an iris pattern under insufficient illumination lower than a predetermined level. It requires a light source which is higher than a predetermined level. Particularly, if LED lamps are used as the light source, a plurality of LED lamps and a controller therefor are needed and thus the structure becomes complicated inevitably.

The conventional iris pattern photographing apparatuses requires a distance measuring module and a focus adjusting module, and an illuminator for providing a high-level illumination, additionally. The apparatus is large, complicated and expensive. Since it is heavy and large, it is difficult or impossible to carry the apparatus and a wide space is required to set it up. Due to the restriction in setup, it cannot be used generally.

### DISCLOSURE OF INVENTION

It is, therefore, an object of the present invention to provide an iris pattern photographing apparatus that can photograph an iris of a person to be identified clearly even in a low-level illumination without a complicated device by using a short lens of a simple structure, which can photograph the iris in a predetermined distance, and making the person place his iris within the focal distance of a digital camera easily; and be produced at a low cost and carried and set up conveniently.

In accordance with one aspect of the present invention, there is provided an iris pattern photographing apparatus, which includes: a body case; a short lens digital camera for photographing an iris pattern of a person to be identified, the short lens digital camera being set up in the body case and including a lens module and an imaging device; light emitting diode (LED) lamps for providing illumination for photographing, the LED lamps being set up around a lens of the digital camera; a power supplying module for supplying power source to the digital camera and the LED lamps; and a focal lens combined with a lens of the digital camera in the front for close contact photographing.

The power source supplying module includes cable for supplying power source through a computer, the cable being connected to any one of input/output ports; and the digital camera, which is connected to another input/output port of the computer through the cable, compares an iris image transmitted from the camera with a pre-registered iris pattern stored in the computer.

Also, the power source supplying module further includes a Universal Serial Bus (USB) controller including one or more USB modules, wherein the USB controller is set up in the body case and the computer.

Further, the iris pattern photographing apparatus of the present invention further includes: a storing module for storing the pre-registered iris pattern, the storing module being set up inside the body case; and a processor for comparing the iris pattern inputted from the digital camera with the iris pattern stored in the storing module, the processor being set up in the inside of the body case.

The LED lamps have a smoothed light concentration part and the LED lamps are set up on both sides of the camera lens in the horizontal direction. The LED lamps on both sides are formed inclined and facing each other within 2 cm from the center of the camera lens to correct a defect in photographing caused by incident reflecting light into the inside of the digital camera.

The LED lamps on both sides of the camera lens are turned on at an interval of 200 mm/s sequentially.

The LED lamps include a cold mirror for selectively penetrating infrared rays in the front part of the digital camera lens.

The cold mirror selectively penetrates only infrared rays having a wavelength band of 800 nm to 900 nm.

The cold mirror has a cross section area, the person to be identified can see that the image of the entire iris is shown in the cold mirror, when the iris of the person to be identified is placed within the focal distance of the digital camera.

The lens module of the digital camera has a focal distance of 16 mm to 25 mm.

The focal lens has a focal distance of 16 mm to 25 mm.

The focal lens is connected to the digital camera lens in the front part, and the focal lens further includes a controller for controlling the focal distance from the digital camera.

The controller is combined with the focal lens and the camera lens movably in the axial direction to thereby obtain a plurality of connection parts.

The body case is formed in a shape of cylinder wrapping the camera lens in the front part of the digital camera lens and the body case includes an external illumination blocking device that can be drawn in and out of the focal lens in the horizontal direction.

The external illumination blocking device is formed in a length that the iris of the person to be identified is placed within the focal distance, when the person to be identified brings the face to a line end part of the external illumination blocking device.

The external illumination blocking device can be drawn in and out manually or automatically and the external illumination blocking device can be drawn in and out of the camera lens in a length of 5 cm to 10 cm.

The body case includes an auxiliary light source for maintaining the size of a pupil regularly by emitting light source around the digital camera lens and a display light source for the person to recognize whether the iris is photographed.

The imaging device is formed of a CCD (CCD) chip of over a third inch or a CMOS chip, and the imaging device is capable of photographing at a low level of illumination.

The body case includes a switch for supplying or shutting off power source to or from the camera and/or LED lamps; and the external illumination blocking device includes a switch controller for turning off the switch based on the movement of the external illumination blocking device.

### BRIEF DESCRIPTION OF DRAWINGS

The above and other objects and features of the present invention will become apparent from the following description of the preferred embodiments given in conjunction with the accompanying drawings, in which:

FIG. 1 is a perspective view showing an iris photographing apparatus in accordance with an embodiment of the present invention;

FIG. 2 is a cross-sectional view obtained by cutting iris photographing apparatus of FIG. 1 in a direction of front to back to reveal the internal structure;

FIG. 3 is a front view describing the iris photographing apparatus of FIG. 2; and

FIG. 4 is a rear view showing the iris photographing apparatus of FIG. 2.

### BEST MODE FOR CARRYING OUT THE INVENTION

Other objects and aspects of the invention will become apparent from the following description of the embodiments with reference to the accompanying drawings, which is set forth hereinafter.

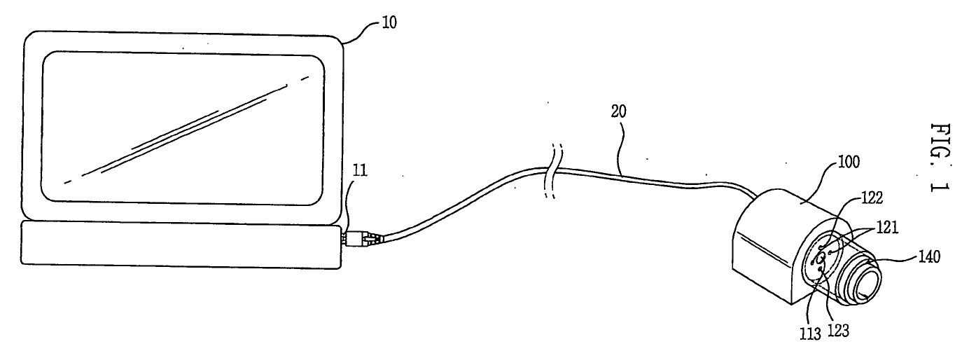

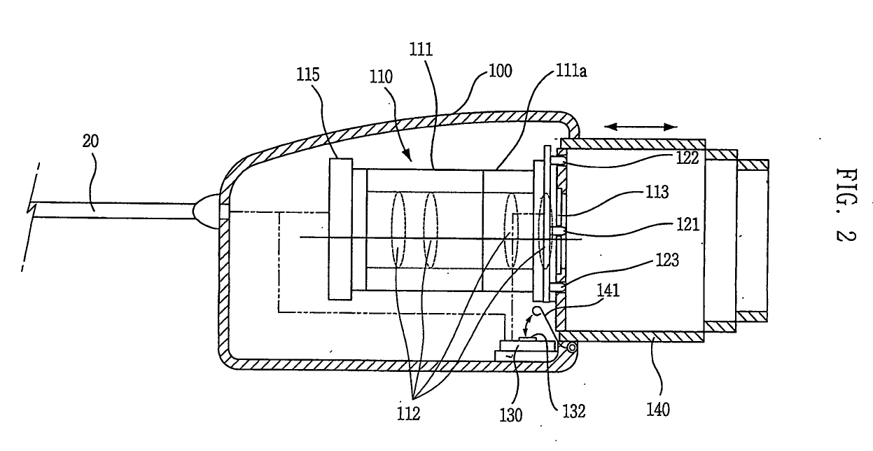

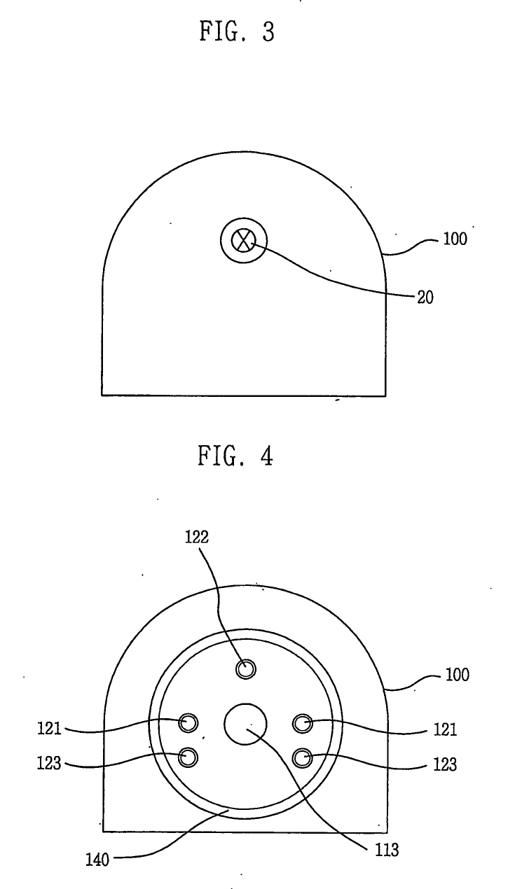

FIG. 1 is a perspective view showing an iris photographing apparatus in accordance with an embodiment of the present invention, and FIG. 2 is a cross-sectional view obtained by cutting the iris photographing apparatus of FIG. 1 in a direction of front to back to reveal the internal structure. FIG. 3 and FIG. 4 are a front view and a rear view describing the iris photographing apparatus of FIG. 2, respectively.

As illustrated in FIGS. 1 and 2, the iris photographing apparatus of the present invention comprises: a body case 100; a short lens digital camera 110 for photographing an iris pattern of a person, the camera 110 being installed in the body case 100 and including a lens module 111 and an imaging device 115; a light emitting diode (LED) lamps 121, which are installed around a lens 112 of the digital camera 110, for providing illumination for photographing; a power supplier for supplying power to the digital camera 110 and the LED lamps 121; and a focal lens 111a, which is joined with the front of the lens of the digital camera 110, for close contact photographing.

The digital camera 110 is a short lens digital camera which is similar to a conventional Personal Computer (PC) camera. It includes a lens module 111 having a plurality of lenses 112 arrayed in a line therein and an imaging device 115, which is joined with the rear part of the lens module 111, for converting an image inputted through the lens 112 into electric signals. Herein, the lens module 111 of the digital camera 110 is formed of board-type lenses with a focal distance of 16 mm to 25 mm. Also, it is preferable that the imaging device 115 is formed of a charge-coupled device (CCD) chip over a third inch or a CMOS chip.

To the front of the lens module 111, a focal lens 11a for adjusting a focal distance of the lens module 111 is connected.

In other words, the lens module 111 and the focal lens 111a are connected to each other movably in the axial direction. For example, they have a plurality of screw joining sections connected to each other with a screw. The iris photographing apparatus further comprises a controller that can adjust the focal distance by rotating each section, if the focal distance needs to be adjusted due to physical characteristics such as the depth of an eye. Herein, the focal lens 111a has a focal distance of 16 mm to 25 mm preferably.

The iris photographing apparatus further comprises a cold mirror 113 in front of the focal lens 111a and the lens module 111 of the body case 100 to selectively penetrate light entering the lens 112 from the outside. The cold mirror blocks incident ultraviolet rays reflected from the face of a person to be identified and the incident infrared rays including ultraviolet rays from an auxiliary light source, which will be described later, and selectively penetrates only single wavelength ultraviolet rays of 800 to 900 nm that are required by the digital camera 110. Also, if the cold mirror 113 recognizes that the iris of the person is placed within the focal distance of the digital camera 110, it is preferable that the cold mirror 113 has a cross section in which the person can see the location of his iris on the cold mirror 113 so that the entire iris of the person to be identified is placed within the exposed surface area of the cold mirror 113.

The LED lamps 121 for illumination are formed of infrared ray (IR) LEDs. The LED lamps 121 are provided around the camera lens 112, particularly, on both horizontal sides of the camera lens 112 and emit light, which is reflected by the iris of the person to be identified and goes into the lens module 111 through the cold mirror 113.

Preferably, smoothing is performed on the light concentration parts of the LED lamps to prevent the emitted light from being concentrated on one spot and the LED lamps 121 are placed within 2 cm from the center of the camera lens 112. This is to secure a sufficient distance for the light emitted from the LED lamps 121 to be recognized by the pupil of the person to be identified.

Also, the LED lamps 121 are turned on sequentially at an interval of 200 mm/s in order to correct a possible defect by the light emitted from an LED lamp on the left or an LED lamp on the right during the photographing. The sequential lighting is to suppress the shadow generated on the opposite side of a globular eye by the light emission of the right or left lamp and search the same image as registered.

Also, the display light source 122 positioned around the camera lens 112 makes the person to be identified recognize whether his iris is photographed while he stares at the cold mirror 113.

The external illumination blocking device 140 is formed in a cylindrical shape and it surrounds the camera lens 112. It is placed in the front part of the camera lens 112 to be movable from the body case 100 in the horizontal direction manually or automatically. In other words, if the external illumination blocking device 140 is drawn out from the body case 100 to the front thereof, the length between the external illumination blocking device 140 and the camera lens 112 is formed the same as or similar to the focal distance of the camera lens 112. Herein, it is preferable that the lengths between the external illumination blocking device 140 and the body case 100 when it is drawn in and out of the body case 100 are about 5 cm and 10 cm, respectively. Thus, if the external illumination blocking device 140 is drawn out of the body case 100 and the face of the person to be identified comes close to it, the iris of the person is positioned within the photographing range approximately.

Also, the external illumination blocking device 140 prevents a possible defect by an external illumination in photographing and makes up a preferable photographing environment by keeping the cold mirror 113, the camera lens 112 and the LED lamp 121 off from the external environment. Particularly, if the person to be identified approaches the external illumination blocking device 140, the camera lens 112 excludes the external illumination and accommodates light of a wavelength band appropriate for photographing, such as light of 850 nm, to obtain a clear image by providing only illumination provided from the LED lamps 121. Herein, the body case 100 is equipped with an auxiliary light source 123 to recognize the position of the iris in the cold mirror 113 in a dark interior formed by the external illumination blocking device 140 and maintain the size of the pupil of the person to be identified regularly.

The camera 110 includes a data cable 20 in order to transmit the photographing image data to a Personal Computer (PC) 10, and the data cable 20 is connected to an input/output port 11 for data transmission, such as Universal Serial Bus (USB) ports 11 of a PC 10.

The body case 100 includes a power input port for receiving electric power from the PC 10 to operate the LED lamps 121 for illumination and display. To the power input port 116, a cable 20 which is the same as a conventional PC-connecting cable is connected and the cable is connected to an input/output port 11 for data transmission of the PC 10. This is because the iris pattern photographing apparatus of the present invention can be operated at a low power supplied through the input/output ports 11 of the PC 10 as it uses a small number of LED lamps 121 for illumination.

Also, the cable can be connected to diverse input/output ports 11 of the PC 10 for data transmission such as parallel ports, serial ports, USB ports and the like.

The apparatus of the present invention further r includes a USB controller provided with one or more USB modules. The USB controller controls illumination required for the photographing of the camera 110 and controls peripheral units such as a locking unit and wiegand. In other words, the USB module has a structure capable of serial connection and 127 types of extensions are possible. Also, it can control a plurality of camera illuminators without additional external power source.

In the embodiment of the present invention, the USB module is used to attach a plurality of cameras to one controller and control illumination. Therefore, if a plurality of cameras are set up in a building, the cameras can be controlled by one controller through the USB module. Consequently, it is possible to set up a plurality of cameras and a controller in a small space.

Further, the external illumination blocking device 140 can be formed to perform switching to supply or shut off power source to the LED lamps 121 according to the position. For example, as illustrated in FIG. 2, the external illumination blocking device 140 can supply or shut off power source by using an on/off switch 132 as a contact switch 132 and placing a conductor 141 in the lower part of the connection between the external illumination blocking device 140 and the body case 100 and thus the conductor 141 contacts or comes off from the contact switch 132 as the external illumination blocking device 140 makes a movement horizontally.

Although it is not presented in the drawings, it is possible to form the external illumination blocking device 140 to perform switching by forming a switch button in the front part of the body case 100 and pressing the switch button when the external illumination blocking device 140 is drawn in and out in the horizontal direction.

Meanwhile, in the PC 10 connected to the camera 110, a program for encoding the photographed iris image, comparing it with the pre-registered iris pattern, and outputting the comparison result is installed and the outputted result can be displayed on a display of the PC 10, audio unit, and the display light source 122. Also, the PC 10 can be connected with an external device that operates based on the result of reading the iris pattern. Examples of the external devices are digital door lock and the like.

The iris pattern photographing apparatus of the present invention with the above-described structure can be operated as follows.

If the external illumination blocking device 140 is drawn out of the body case 100 automatically or manually with the cable 20 connected to the input/output port 11 of the PC 10, the conductor 141 of the external illumination blocking device 140 comes off the contact switch 132 and power is supplied to the LED lamps 121 for illumination and the camera 110. Herein, the iris pattern analyzing program is in the middle of running or begins running and photographing by the camera 110 is started and photographed video signals are inputted to the PC 10.

That is, the iris of the person to be identified is positioned within the focal distance approximately, as the person to be identified places his eye in the directional line of the cold mirror 113 and brings it close to the end of the external illumination blocking device 140, while the external illumination blocking device 140 is drawn out toward the front. The person to be identified can adjust the iris to the precise focus for photographing by staring the cold mirror 113 to look at the entire iris within the reflection area of the cold mirror 113. Herein, the external illumination blocking device 140 adjusts the length from the camera 110 into the optimum focal distance based on his physical characteristics whether he wears glasses.

At the same time, the iris pattern is photographed at a predetermined time interval in the camera 110 and the photographed image is transmitted to the PC 10 in real-time. Subsequently, the photographed iris pattern is compared with the pre-registered iris pattern stored in the PC 10 and the process is displayed on a display to be observed by the user.

The LED lamps 122 for display flickers based on the analysis result to show the user whether he is authenticated.

As described above, the iris pattern photographing apparatus of the present invention uses a digital camera 110 with a fixed focus to photograph the iris pattern, it has a simple structure and it can be miniaturized easily because it does not require a focal distance measuring unit or focus adjusting unit to adjust the focus automatically.

Also, since it can acquire a good-quality image under a low level of illumination with a small number of LED lamps 121 by photographing the iris at a short distance with the focal lens 111a, the structure for controlling the illumination can be simplified and the iris pattern photographing apparatus can be operated at a low power source provided through the input/output port of the PC 10.

Therefore, the iris pattern photographing apparatus of the present invention is small and simple in the structure and requires small space for setup. Thus, users can set it up at any place they want without restriction and they can use it generally for a remarkably reduced production cost. For example, an iris recognition system can be used for controlling entrance and exit of a safe or a building. Since the iris pattern photographing apparatus occupies small setup space, it can be set up easily by filling it in the door as well as a wall around an entrance. So, it can be incorporated with the door.

Meanwhile, although the aforementioned embodiment presents an example of using the apparatus by connecting it to the PC 10, the present invention is not limited to it and it can be formed independently without connection to an external device by including a processor for reading an image and a memory for storing authenticated iris pattern data in the body case 100 to thereby recognize and read the iris pattern. In this structure, it can be used more conveniently by being incorporated with a door.

As described above, the iris pattern photographing apparatus of the present invention does not have to include a focal distance measuring unit and a focus adjusting unit to control the focus automatically by using a short lens digital camera to photograph an iris. Therefore, the structure of the iris pattern photographing apparatus can be simplified and since it can be miniaturized, it can be set up in a small space such as a front door.

Further, since the iris pattern photographing apparatus uses a focal lens to photograph the iris pattern in a close distance, it can take a precise photograph of the iris pattern with a small number of LED lamps. Therefore, the illuminator for photographing the iris pattern and a controlling structure thereof can be simplified and the iris pattern photographing apparatus can be operated at a low level of power.

While the present invention has been described with respect to certain preferred embodiments, it will be apparent to those skilled in the art that various changes and modifications may be made without departing from the scope of the invention as defined in the following claims.

1. An iris pattern photographing apparatus, comprising:
a body case;
a short lens digital camera for photographing an iris pattern of a person to be identified, the short lens digital camera being set up in the body case and including a lens module and an imaging device;
light emitting diode (LED) lamps for providing illumination for photographing, the LED lamps being set up around a lens of the digital camera;
a power supplying means for supplying power source to the digital camera and the LED lamps; and
a focal lens combined with a lens of the digital camera in the front for close contact photographing.

2. The iris pattern photographing apparatus as recited in claim 1, wherein the power source supplying means includes cable for supplying power source through a computer, the cable being connected to any one of input/output ports; and
the digital camera, which is connected to another input/output port of the computer through the cable, compares an iris image transmitted from the camera with a pre-registered iris pattern stored in the computer.

3. The iris pattern photographing apparatus as recited in claim 1, wherein the power source supplying means further includes:
a Universal Serial Bus (USB) controller including one or more USB modules, the USB controller being set up in the body case and the computer.

4. The iris pattern photographing apparatus as recited in claim 1, further comprising:
a storing means for storing the pre-registered iris pattern, the storing means being set up inside the body case; and
a processor for comparing the iris image inputted from the digital camera with the iris pattern stored in the storing means, the processor being set up in the inside of the body case.

5. The iris pattern photographing apparatus as recited in claim 1, wherein the LED lamps have a smoothed light concentration part and the LED lamps are set up on both sides of the camera lens in the horizontal direction, the LED lamps on both sides being formed inclined and facing each other to correct a defect in photographing caused by incident reflecting light into the inside of the digital camera.

6. The iris pattern photographing apparatus as recited in claim 1, wherein the LED lamps are formed within 2 cm from the center of the camera lens.

7. The iris pattern photographing apparatus as recited in claim 1, wherein the LED lamps on both sides of the camera lens are turned on at an interval of 200 mm/s sequentially.

8. The iris pattern photographing apparatus as recited in claim 1, wherein the LED lamps include infrared ray LEDs and a cold mirror for selectively penetrating infrared rays in the front part of the digital camera lens.

9. The iris pattern photographing apparatus as recited in claim 8, wherein the cold mirror selectively penetrates only infrared rays having a wavelength band of 800 nm to 900 nm.

10. The iris pattern photographing apparatus as recited in claim 8, wherein the cold mirror has a cross section area so that the person to be identified can see that the image of the entire iris is shown in the cold mirror, when the iris of the person is placed within the focal length of the digital camera.

11. The iris pattern photographing apparatus as recited in claim 1, wherein the lens module of the digital camera has a focal length of 16 mm to 25 mm.

12. The iris pattern photographing apparatus as recited in claim 1, wherein the focal lens has a focal length of 16 mm to 25 mm.

13. The iris pattern photographing apparatus as recited in claim 1, wherein the focal lens is connected to the digital camera lens in the front, and the focal lens further includes a controller for controlling the focal length from the digital camera.

14. The iris pattern photographing apparatus as recited in claim 13, wherein the controller is combined with the focal lens and the camera lens movably in the axial direction to thereby obtain a plurality of connection parts.

15. The iris pattern photographing apparatus as recited in claim 1, wherein the body case is formed in a shape of cylinder wrapping the camera lens in the front of the digital camera lens, and the body case includes an external illumination blocking device that can be drawn in and out of the focal lens in the horizontal direction.

16. The iris pattern photographing apparatus as recited in claim 15, wherein the external illumination blocking device is formed in a length that the iris of the person to be identified is placed within the focal length, when the person to be identified brings the face to a line end part of the external illumination blocking device.

17. The iris pattern photographing apparatus as recited in claim 15, wherein the external illumination blocking device can be drawn in and out manually or automatically and the external illumination blocking device can be drawn in and out of the camera lens in a length of 5 cm to 10 cm.

18. The iris pattern photographing apparatus as recited in claim 1, wherein the body case includes an auxiliary light source for maintaining the size of a pupil regularly by emitting light source around the digital camera lens.

19. The iris pattern photographing apparatus as recited in claim 1, wherein the body case further includes a display light source for the person to be identified to recognize whether the iris of the person to be identified is photographed.

20. The iris pattern photographing apparatus as recited in claim 1, wherein the imaging device is formed of a Charge-Coupled Device (CCD) chip of over a third inch or a CMOS chip, the imaging device capable of photographing at a low level of illumination.

21. The iris pattern photographing apparatus as recited in claim 1, wherein the body case includes a switch for supplying or shutting off power source to or from the camera and/or LED lamps; and the external illumination blocking device includes a switch controller for turning off the switch based on the movement of the external illumination blocking device.
